(19) United States
(12) Patent Application Publication
(10) Pub. No.: US 2003/0107498 A1
(43) Pub. Date: Jun. 12, 2003

(54) Automated space availability coordinator

(76) Inventor: George A. Drennan, Eagle, ID (US)

Correspondence Address: HEWLETT-PACKAD COMPANY, Intellectual Property Administration, P.O. Box 272400, Fort Collins, CO, 80527-2400, US

(21) Appl. No.: 10/012,750

(22) Filed: Dec. 7, 2001

(51) Int. Cl. H04Q 1/00

(52) U.S. Cl. 340/825.28; 705/5; 340/825.49; 340/995.1

(57) ABSTRACT

A system and method is described for determining the most efficient space or cell for a user within a group of spaces or cells. A preferred embodiment implements an automated available unit locator for a multiple unit network comprising an occupancy sensor for determining an occupancy status or availability of each unit in the multiple unit network. The locator also has an apparatus for calculating the most efficient available unit based, at least in part, on the occupancy status of each unit. The location of the calculated most efficient available unit is then communicated to the user with a communication interface.

### TECHNICAL FIELD

This application relates to space management, and more particularly to a system and method for selectively determining space availability within a multiple-space network.

### BACKGROUND OF THE INVENTION

Multiple-unit networks permeate the industrialized world. A multiple-unit network generally comprises a system of cells or units (e.g., parking spaces, storage lockers, safety deposit boxes, and the like) gathered in a multiple-unit configuration (e.g., a parking lot, storage area of a train station, a bank, an amusement park etc.). In the typical case, a user generally either tries to find an available unit or, if the user has already occupied the space, he or she may have to find the cell or unit they are using. When the network comprises only a few such units, the search process does not generally last very long. However, in the situation of a multi-storied parking garage or a room with a thousand storage lockers, it may take a user a substantial amount of time to locate an available unit or space. Additionally, where a parking lot is connected to a large facility, such as an airport, a seemingly “close” parking space, may, in fact, turn out to be extremely inconvenient to the user's eventual airport destination.

Another disadvantage with networks, such as current parking lots, is the throughput efficiency of the parking lot. For example, if three drivers enter a parking garage in sequence, the first driver typically dictates the speed and efficiency with which all three drivers find a space to park. If the third driver leases an assigned space in the garage, his or her travel time from garage entrance to assigned space will generally be unpredictable based on the attitude and abilities of the other two drivers. One driver may proceed slowly, stopping at every cross section to check for available spaces, even when it is unlikely for a space to be available based on elements such as the time of day, classification of the surrounding parking spaces (i.e., reserved spaces when the driver is not a space lessor), and the like. The unpredictability of space locations along with the unpredictability of a driver may seriously delay drivers attempting to park and reach their destination in a timely fashion.

In some circumstances, a driver may enter a garage that is already completely full and waste a large amount of time driving through the entire garage only to find no spaces. Handicapped drivers may also face difficulties finding available handicapped parking that may not be placed in obvious locations.

Another example of a multiple-unit network is a storage facility at a transportation terminal. Airports, train stations, and bus stations typically have storage lockers available to travelers for temporarily storing luggage or other items not necessary to be with the traveler at all times or that the traveler simply does not want to carry for the moment. Because many such facilities use lockers that may generally appear closed, it is usually extremely difficult to find an available locker without having to try each one, one at a time. Additionally, an empty locker may be empty because it is broken or out of service. The only current method for finding an available locker which is not broken is to physically check each locker. This method costs time and may adversely effect a travelers ability to complete a task before he or she is required to continue traveling.

Advances have been made in the parking industry toward automation and space availability determination. An example of such advancement is present at the Baltimore-Washington International Airport. Sensors have been placed within the parking garage that sense when each space is occupied or empty. Through a computer system connected to these sensors, the number of spaces available are displayed to motorists using strategically placed signs. A typical sign will indicate the number of spaces open and typically display an arrow pointing in the direction of the open spaces. As the spaces in a particular parking section are completely filled, the sign changes display to indicate the unavailable status.

Such smart parking systems, while just recently being implemented in the United States, have existed in Europe for many years. Smart parking system companies, such as the Swiss company Schick Electronics, SA, suggest implementations of reserve parking, in which specific motorists are given specific spaces that are reserved only for that motorist as he or she enters the garage.

While such smart parking systems have advanced the convenience and efficiency of current parking space management techniques, they still fall short of fully integrating a system for providing increased efficiency features for both the owners of the parking garage and the motorists utilizing the garages.

### BRIEF SUMMARY OF THE INVENTION

In consideration of the problems present in the current systems and methods for determining available spaces in a group of spaces, it would be beneficial to have an automated space locator for determining the best available space for each user. The present invention is directed to a system and method for directing a user to the space or cell within a group of spaces or cells that is most efficient for the user. A preferred embodiment of the present invention implements an automated available unit locator for a multiple unit network comprising an occupancy sensor for determining an occupancy status of each unit in the multiple unit network. The locator also has an apparatus for calculating the most efficient available unit responsive at least in part to the occupancy status of each unit. Once the locator calculates the most efficient available unit the location of the calculated unit is communicated to a user with a communication interface.

### BRIEF DESCRIPTION OF THE DRAWINGS

FIG. 1A is a perspective view illustrating a preferred embodiment of the present invention configured to coordinate spaces in a parking lot;

FIG. 1B is a close up perspective view of an access station as part of the preferred embodiment shown in FIG. 1A;

FIG. 2A is a perspective view illustrating an alternative embodiment of the present invention configured to coordinate spaces in a parking lot;

FIG. 2B is a close up perspective view of a single parking space as configured in the embodiment shown in FIG. 2A;

FIG. 3A is a perspective view illustrating a further alternative embodiment of the present invention configured to manage available storage lockers;

FIG. 3B is a close up perspective view illustrating a locker machine access station as part of the preferred embodiment shown in FIG. 3A;

FIG. 3C is a close up perspective view illustrating an individual locker as part of the preferred embodiment shown in FIG. 3A; and

FIG. 4 is a flow chart describing the steps performed in implementing a preferred embodiment of the present invention.

### DETAILED DESCRIPTION OF THE INVENTION

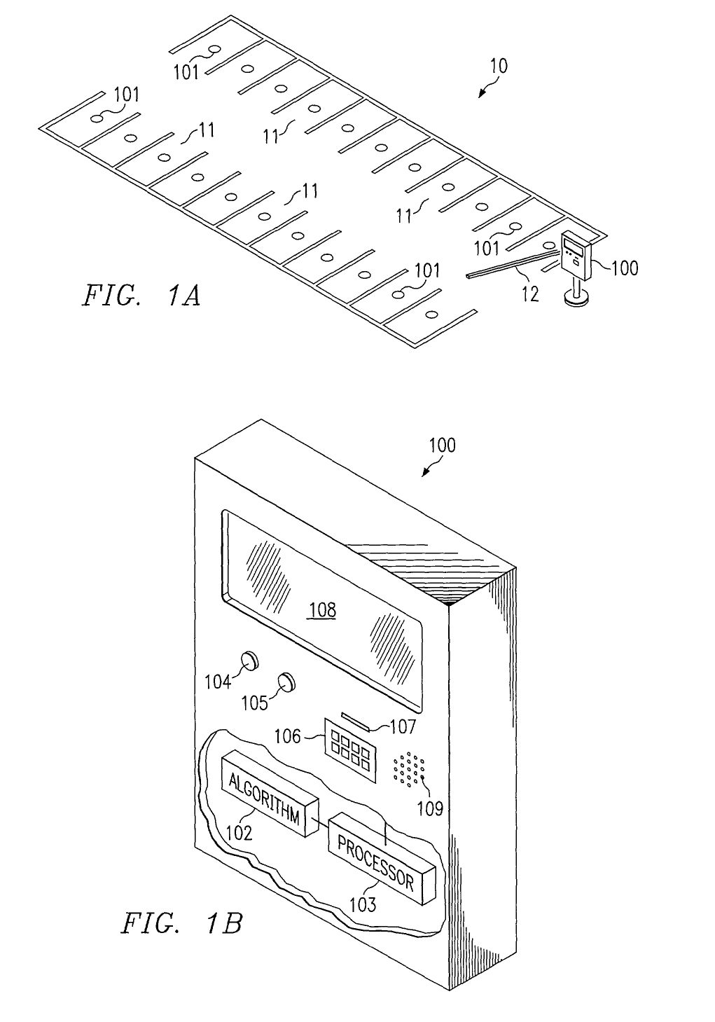

FIG. 1A illustrates one potential application for a preferred embodiment of the present invention configured to work with a parking lot. Parking lot 10 comprises group of parking spaces 11. Access to parking lot 10 is controlled by lift gate 12. Access station 100 preferably acts as the interface point with users desiring to enter parking garage 10. Each of group of parking spaces 11 is preferably equipped with sensors 101 that detect the occupancy, and thus the availability, of each of group of parking spaces 11.

FIG. 1B is a close up view of access station 100. Apparatus 102 and processor 103 preferably process the availability and/or occupancy information from sensors 101 (FIG. 1A) in order to derive the most efficient available space. As a user approaches access station 100, he or she may preferably interface with any of buttons 104 and 105, or keypad 106 to select any destination or enter any other information useful to parking. In addition to the availability and/or occupancy information, apparatus 102 and processor 103 may also preferably use the user-entered data to calculate the most efficient space.

For example, in FIG. 1A, if parking lot 10 were connected to an airport, the user may preferably enter the airline he or she is using to depart, or may even preferably enter the flight information for someone the user is there to pick up. Using this information and the availability and/or occupancy information from sensors 101, apparatus 102 and processor 103, from FIG. 1B, preferably calculate the most efficient available space for the user to park in. This most efficient available space would preferably comprise the space closest to the user's ultimate destination. Access station 100 would preferably communicate the location of the calculated space to the user and open lift gate 12 to allow the user to access parking lot 10.

It should be noted that in alternative embodiments, different means for providing a user interface may be implemented. In some embodiments, access station 100 may preferably incorporate voice recognition technology to allow the user to speak all necessary information directly to access station 100. In other embodiments, an image reader may be used to read user documents which may be useful for parking purposes, such as an airline ticket. In such alternative embodiments, the user would insert his or her airline ticket into the image reader. The image reader then preferably reads the flight information from the ticket, communicates with a centralized database, determines the gate information, and then calculates the most efficient available space using all of this information. In such an embodiment, access station 100 may preferably issue a ticket (not shown) that indicates the user's scheduled gate.

As shown in FIG. 1B, access station 100 preferably communicates the calculated most efficient available space to the user through any number of different and available ways. The user may preferably receive a ticket (not shown) from slot 107 which indicates the location of the most efficient available space of group of parking spaces 11 (FIG. 1A). Additionally or alternatively, display 108 may preferably display a map of parking lot 10 (FIG. 1A) allowing the user to find the location of the communicated space. Display 108 may also preferably display an interactive map that animates the specific location of the most efficient space. Display 108 may accomplish this by preferably providing lighted map directions or may even play a video to the user to show the desired location. In alternative embodiments, display 108 may preferably display all available spaces in addition to the most efficient space. Additionally or alternatively, access station 100 may preferably play an audio file describing the location of the space using speaker 109. Using this location information, the user preferably knows how to find the most efficient space in which to park.

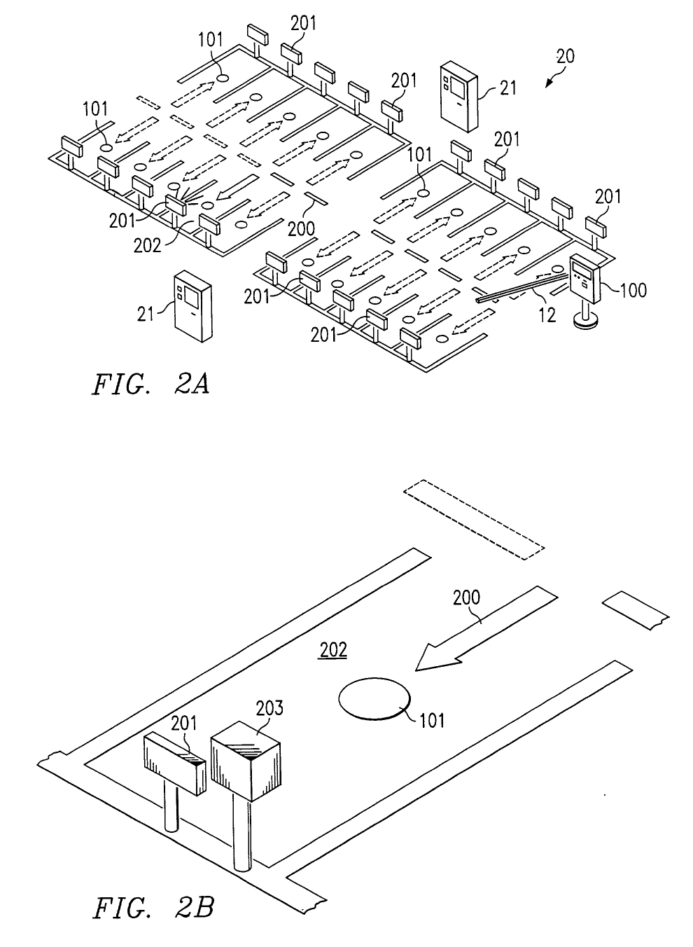

FIG. 2A illustrates a further alternative embodiment of the present invention configured with parking lot 20. Parking lot 20 may be accessed via lift gate 12 and is preferably equipped with lighted arrow marker 200 that illuminates the path to best available parking cell 202. This allows access station 100 to preferably show the user the location and direction to best available parking cell 202. As the user receives the location of best available parking cell 202 from access station 100, arrow marker 200 preferably lights up specifically directing the user to its location.

It should be noted that in additional embodiments of the present invention, each of the parking cells in parking lot 20 is preferably equipped with cell display 201 for displaying the location of the cell. For example, if all of the parking cells were numbered, cell display 201 in best available parking cell 202 would preferably light up the number corresponding to best available parking cell 202. Such an element may preferably be used in conjunction with or in the alternative to arrow marker 200 to direct the user through parking lot 20 to locate best available parking cell 202.

As shown in FIG. 2B, it should further be noted that in other additional embodiments, a user may preferably be specifically assigned to best available parking cell 202. In the present embodiment, access station 100 (FIG. 2A) issues a ticket with a magnet strip to store the assigned location for best available parking cell 202. The additional alternative embodiment preferably includes verifier 203 in each of the cells in parking lot 20 (FIG. 2A) to verify the reservation. In operation, when the user receives the location of best available parking cell 202, both arrow marker 200 and cell display 201 preferably activate, directing the user to best available parking cell 202. After a user parks in best available parking cell 202, he or she presents the ticket to be read by verifier 203. If verifier 203 indicates the user parked in the wrong cell, both arrow marker 200 and cell display 201 would preferably remain activated, showing the user that he or she parked in the wrong spot. If the user had parked in the correct spot, verifier 203 preferably deactivates arrow marker 200 and cell display 201.

Referencing back to FIG. 2A, it should be noted that in such a reservation system, access station 100 would preferably designate best available parking cell 202 as occupied in order to keep it from being calculated as the most efficient cell or space for another user. This prevents two users from being assigned the same location to the same cell or space. In order to improve the efficiency of the cell management system, access station 100 preferably provides a predefined or predetermined amount of time for the user to find and occupy best available parking cell 202 before best available parking cell 202 is released and re-designated unoccupied. The predefined amount of time is preferably long enough to allow a slow user to find and occupy the cell. Therefore, if a user enters parking lot 20 and then decides to exit before finding and occupying best available parking cell 202, best available parking cell 202 would only preferably be unavailable for the predetermined time before being made available again for another user.

In an alternative embodiment of the present invention depicted in FIG. 2A, one or more of remote stations 21 are added to parking lot 20 at different and various pedestrian access points. A user parks in best available parking cell 202 and proceeds to his or her destination. When the user returns to parking lot 20, he or she may have forgotten where he or she has parked. In order to find best available parking cell 202 again, the user may allow remote station 21 to read the ticket or card provided by access station 100. Remote station 21 displays the location of best available parking cell 202 to the user based on any information contained on the ticket or card's magnetic strip. This provides better security for users both in knowing where their cars are located and, thus, spending less time wandering in a parking lot, but also allows users to determine if their cars have been stolen more quickly, saving valuable time in contacting authorities for assistance.

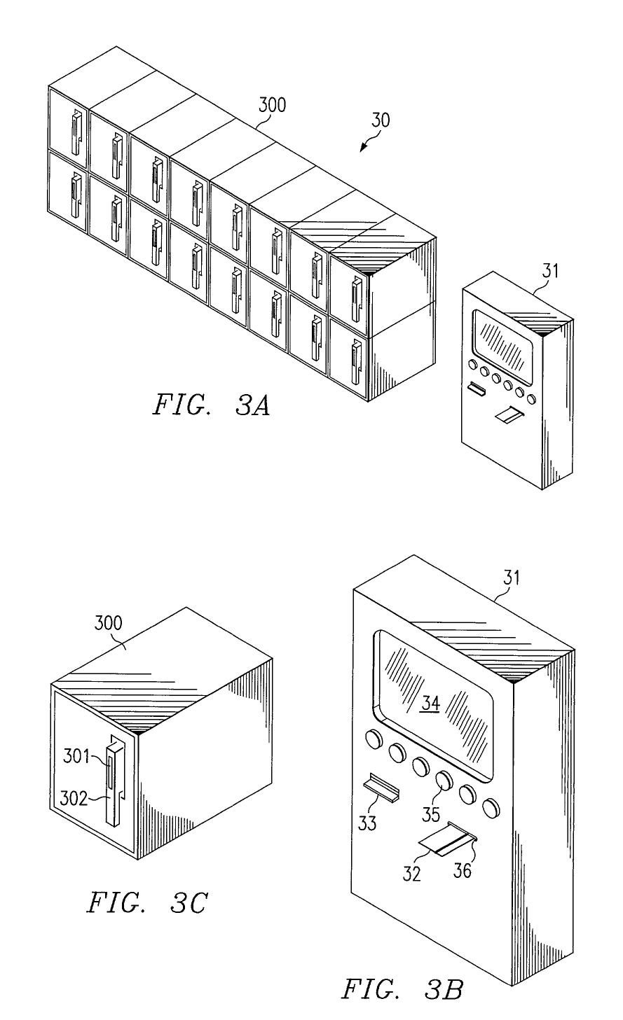

The present invention may also be applied to other groups of spaces such as in a network of storage lockers. FIG. 3A illustrates storage lockers 30. The system is preferably managed at locker machine 31. As shown in FIG. 3B, locker machine 31 preferably comprises display screen 34, interface keys 35, money receptacle 33, and card dispenser 36. A user desiring to rent a locker preferably interacts with interface keys 35 and pays a rental fee by inserting money into money receptacle 33. Locker machine 31 preferably dispenses key card 32 to the user which directs the user to storage locker 300 (FIGS. 3A and 3C). The location may also preferably be displayed on display screen 34 as described above. Once key card 32 has been dispensed, locker machine 31 preferably removes storage locker 300 (FIGS. 3A and 3C) from availability in order to prevent another user being assigned the same space.

Turning to FIG. 3C, the user goes to storage locker 300 and deposits any and all property that the user desires to place in storage locker 300. Using handle 302, the user preferably closes the door to storage locker 300. When locker 300 has been closed the user will preferably insert key card 32 (FIG. 3B) into key slot 301. Key card 32 (FIG. 3B) preferably has a magnetic strip that is read by key slot 301 and which will activate a locking mechanism in handle 302. The user then preferably removes key card 32 (FIG. 3B) from key slot 301 and may leave the area with storage locker 300 closed and locked. If the user desires to open storage locker 300, he or she may preferably insert key card 32 (FIG. 3B) into key slot 301. The magnetic strip on key card 32 (FIG. 3B) will then preferably unlock storage locker 300 allowing the user to retrieve its contents.

As shown in FIG. 3A, it should be noted that a user typically may rent a storage locker only for a limited time based on the amount of money deposited. In a preferred embodiment of the present invention, the magnetic strip on key card 32 also preferably includes timing information which will allow the system to calculate the amount of time the user is allowed to access storage locker 300. This system prevents previous users from accessing lockers that may contain new users' property. In alternative embodiments, key card 32 may include use information for restricting a user to only a single or pre-determined number of uses associated with the amount of money deposited.

It should also be noted that key card 32, shown in FIG. 3A, may alternatively use other methods of information storage, such as a bar code, infrared code, or other similar information code for communicating information in an automated manner.

The system also preferably uses the timing information to control the user's access to storage locker 300, as shown in FIG. 3C. If the user keeps his or her material in storage locker 300 past the rented time, storage locker 300 will not open for the user when key card 32 (FIG. 3B) is inserted into key slot 301. The storage system will preferably require the user to provide additional money for the additional rental time. The system may preferably allow the user to deposit the money directly at storage locker 300, or may preferably require the user to deposit the additional money at locker machine 31 (FIGS. 3A and 3B).

It should be noted that in alternative embodiments, a smart card containing a semiconductor microchip may preferably be used instead of a magnetic striped ticket or card. In such embodiments, key slot 301 and key card 32 (FIG. 3B), which may be fabricated with a contact point, capacitive coupling, or the like, allowing the electronic communication of all appropriate and required information stored on the smart card.

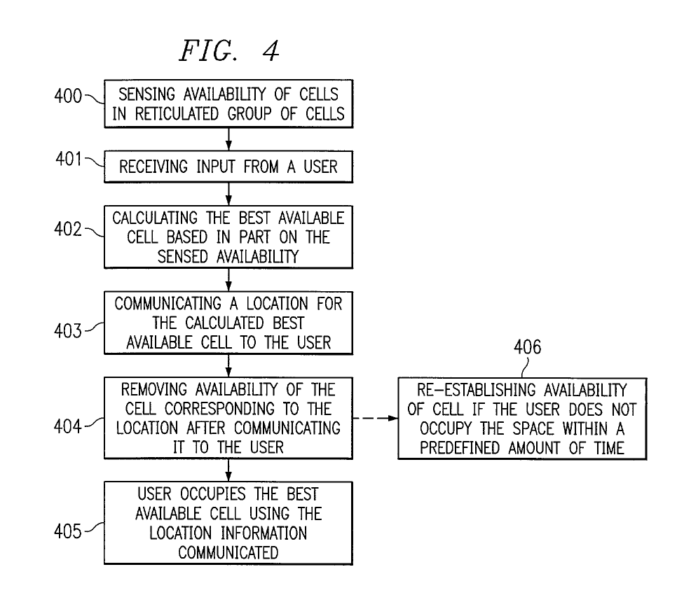

FIG. 4 is a flow chart of the steps performed in implementing a preferred embodiment of the present invention. The availability information of each available space or cell in a group of cells is sensed in step 400. In step 401, input from a user is received. The best available cell is then calculated in step 402 using the sensed availability information and the user's input. In step 403, the location corresponding to the calculated best available cell is communicated to the user. Once the location of the best cell is communicated to the user, the system removes the availability of that cell in step 404. Using the location information communicated in step 403, the user finds and occupies the best available cell in step 405. If the user either does not find the best available cell or decides not to use the best available cell, the system re-establishes the availability of the best available cell in step 406 in order to make that cell available to other potential users.

It should be noted that while the examples described herein were limited to parking lots and storage lockers, the present invention is not limited only to such embodiments. The present invention may be applied to any number of different systems and/or networks of spaces and/or cells for efficiently locating the best available options for a user.

What is claimed is:

1. An automated available unit locator for a multiple unit network comprising:
an occupancy sensor for determining an occupancy status of each unit in said multiple unit network;
an apparatus for calculating a most efficient available unit responsive at least in part to said occupancy status of each said unit; and
a communication interface for communicating a location of said most efficient available unit to a user.

2. The automated available unit locator of claim 1 further comprising:
a user interface for receiving user input, wherein said apparatus uses said user input in determining said most efficient available unit.

3. The automated available unit locator of claim 1 wherein said communication interface communicates said location to said user using at least one of:
a ticket;
an audio message;
a video message;
a map; and
a path indicator within said multiple unit network.

4. The automated available unit locator of claim 1 further comprising:
a remote interface for additionally providing said location of said most efficient available unit to said user when said user is remote to said multiple unit network.

5. The automated available unit locator of claim 1 wherein said most efficient available unit is reserved for said user to whom said location is communicated.

6. The automated available unit locator of claim 5 wherein said most efficient available unit corresponding to said location is designated as occupied when said location is communicated to said user.

7. The automated available unit locator of claim 6 wherein said most efficient available unit corresponding to said location is re-designated as unoccupied when said user does not occupy said most efficient available unit after a predetermined length of time.

8. The automated available unit locator of claim 1 wherein said unit is a parking space and said multiple unit network is a parking lot.

9. The automated available unit locator of claim 1 further comprising a verifier at said most efficient available unit for verifying that said user is at said location.

10. The automated available unit locator of claim 3 wherein said ticket holds data relevant to said most efficient available unit.

11. The automated available unit locator of claim 10 wherein said ticket controls access to said most efficient available unit.

12. A method for assigning cells in a group of cells comprising the steps of:
sensing an availability of each cell in said group of cells;
calculating a most desirable available cell based in part on said sensing step; and
communicating a location of said desired available cell to a user.

13. The method of claim 12 further comprising:
receiving input from said user, wherein said input is used in said calculating step.

14. The method of claim 12 wherein said communicating step comprises at least one of the steps of:
issuing said user a card indicating said location;
illuminating said location using a map of said group of cells;
playing a video of said location;
aurally announcing said location; and
illustrating a path to said location on said group of cells.

15. The method of claim 12 further comprising the step of:
removing said availability for said most desirable available cell corresponding to said location.

16. The method of claim 15 further comprising the step of:
re-establishing said availability for said desired available cell corresponding to said location when said user fails to occupy said location after a predefined amount of time.

17. The method of claim 4 further comprising the step of:
storing information relevant to said most desirable available cell on said card.

18. The method of claim 17 further comprising the step of:
controlling access to said most desirable available cell using said card.

19. An automatic space locator comprising:
means for sensing an occupancy status of a space;
means for receiving input from a user;
means for calculating a best open space based in part on said occupancy status and said user input; and
means for communicating a location of said best open space.

20. The automatic space locator of claim 19 further comprising:
means for restricting access to said best open space responsive to said means for communicating.
